(19) United States
(12) Patent Application Publication
(10) Pub. No.: US 2026/0310833 A1
(43) Pub. Date: Oct. 8, 2026

(54) Non-Disruptive Self-Encrypting-Drive Encryption Key Switching

(71) Applicant: Dell Products L.P., Round Rock, TX (US)

(72) Inventor: Chetan Ramchandra Kulkarni, PUNE (IN)

(21) Appl. No.: 19/169,905

(22) Filed: Apr. 3, 2025

(51) Int. Cl. G06F 21/78; G06F 21/57; G06F 21/60

(52) U.S. Cl. CPC G06F 21/78; G06F 21/572; G06F 21/602

(57) ABSTRACT

A system can encrypt data of a self-encrypting drive using a device encryption key, wherein the self-encrypting drive comprises a priority list of encryption ciphers, and wherein the device encryption key comprises a first key value. The system can, select a second encryption cipher from the priority list, generate a second key value based on the second encryption cipher, decrypt the data of the self-encrypting drive using the device encryption key, to produce read and decrypted data, update the device encryption key based on the second key value, to produce an updated device encryption key, and write the read and decrypted data to the self-encrypting drive, wherein the writing comprises encrypting the read and decrypted data using the updated device encryption key. The system can process reads and writes for the self-encrypting drive using the updated device encryption key.

### BACKGROUND

Data on a storage device can be encrypted, or otherwise protected.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can encrypt data of a self-encrypting drive using a device encryption key that is stored on the self-encrypting drive, wherein the self-encrypting drive comprises a priority list of encryption ciphers, and wherein the device encryption key comprises a first key value. The system can, based on determining to change a currently applicable encryption of the self-encrypting drive, select a second encryption cipher from the priority list of encryption ciphers, generate a second key value based on the second encryption cipher, decrypt the data of the self-encrypting drive using the device encryption key, to produce read and decrypted data, update the device encryption key based on the second key value, to produce an updated device encryption key, write the read and decrypted data to the self-encrypting drive, wherein the writing comprises encrypting the read and decrypted data using the updated device encryption key, and disable a first encryption cipher that corresponds to the first key value with respect to encrypting and decrypting any of the data stored on the self-encrypting drive. The system can process reads and writes for the self-encrypting drive using the updated device encryption key.

An example method can comprise encrypting, by a system comprising at least one processor, data of a self-encrypting drive with a device encryption key that is stored on the self-encrypting drive, wherein the self-encrypting drive comprises a priority list of encryption ciphers. The method can further comprise generating, by the system, a key value based on an encryption cipher that is selected from the priority list of encryption ciphers. The method can further comprise decrypting, by the system, the data of the self-encrypting drive with the device encryption key, to produce read and decrypted data. The method can further comprise updating, by the system, the device encryption key based on the key value, to produce an updated device encryption key. The method can further comprise writing, by the system, the read and decrypted data to the self-encrypting drive, wherein the writing comprises encrypting the read and decrypted data with the updated device encryption key. The method can further comprise processing, by the system, reads and writes for the self-encrypting drive with the updated device encryption key.

An example non-transitory computer-readable medium can comprise instructions that, in response to execution, cause a system comprising a processor to perform operations. These operations can comprise generating a key value based on an encryption cipher that is selected from a priority group of encryption ciphers that is stored on a self-encrypting drive that encrypts data with a device encryption key. These operations can further comprise decrypting the data of the self-encrypting drive with the device encryption key, to produce read and decrypted data. These operations can further comprise updating the device encryption key based on the key value, to produce an updated device encryption key. These operations can further comprise writing the read and decrypted data to the self-encrypting drive, wherein the writing comprises encrypting the read and decrypted data with the updated device encryption key. These operations can further comprise processing reads and writes for the self-encrypting drive with the updated device encryption key.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate non-disruptive self-encrypting drive (SED) encryption key switching, in accordance with an embodiment of this disclosure;

FIG. 2 illustrates an example of non-disruptive SED encryption key switching, in accordance with an embodiment of this disclosure;

FIG. 3 illustrates an example that can facilitate non-disruptive SED encryption key switching, in accordance with an embodiment of this disclosure;

FIG. 4 illustrates an example of an on-SED data buffer, and that can facilitate non-disruptive SED encryption key switching, in accordance with an embodiment of this disclosure;

FIG. 5 illustrates an example of separate temporary storage device, and that can facilitate non-disruptive SED encryption key switching, in accordance with an embodiment of this disclosure;

FIG. 6 illustrates an example of performing a read while performing facilitate non-disruptive SED encryption key switching, and that can facilitate non-disruptive SED encryption key switching, in accordance with an embodiment of this disclosure;

FIG. 7 illustrates another example of performing a read while performing facilitate non-disruptive SED encryption key switching, and that can facilitate non-disruptive SED encryption key switching, in accordance with an embodiment of this disclosure;

FIG. 8 illustrates an example process flow that can facilitate non-disruptive SED encryption key switching, in accordance with an embodiment of this disclosure;

FIG. 9 illustrates another example process flow that can facilitate non-disruptive SED encryption key switching, in accordance with an embodiment of this disclosure;

FIG. 10 illustrates another example process flow that can facilitate non-disruptive SED encryption key switching, in accordance with an embodiment of this disclosure;

FIG. 11 illustrates an example block diagram of a computer operable to execute an embodiment of this disclosure.

### DETAILED DESCRIPTION

### Overview

A self-encrypting drive (SED) generally comprises a type of computer data-storage hard drive that provides hardware-based encryption to protect sensitive data. A component of a SED can be a device encryption key (DEK, sometimes referred to as a disk encryption key), which can be used to encrypt and decrypt the data on the disk. The disk can use the DEK to encrypt data as it writes, and then to decrypt the data as it is read from disk.

SED vendors can implement industry standards from the Trusted Computing Group (TCG) to implement SEDs. The TCG Opal 2.0 or Enterprise specification generally provides a set of guidelines for creating encryption keys in SED using advanced encryption standard (AES) techniques, such as with a key size of either 118 or 256 bits. Hence, currently, SED vendors can use AES techniques to generate an encryption key.

A problem with SEDs can stem from having only one algorithm option to create the encryption key, which can make all SED data in customer products attackable and vulnerable if that algorithm is found vulnerable. This is a single point of failure, and even if one thinks of changing the encryption key, it could still be with the same algorithm, which is hardcoded in the SED. This can mean that users are not assured of the security of their data, and there is no remedy even when a vulnerability is discovered. Hence, relying solely on a single AES algorithm for encryption key creation can have problems.

Prior approaches to SEDs use a static option of using an encryption algorithm, such as AES, which cannot be changed. It can be that encryption algorithms can generally become vulnerable over time. For example, algorithms like Data Encryption Standard (DES) and Rivest Cipher 4 (RC4) were once considered secure but are now widely regarded as insecure. Similarly, it can be that AES or another single algorithm used by SEDs will eventually become vulnerable and need to be replaced.

The present techniques can address these problems with prior approaches by making the algorithm used for encryption dynamic. Instead of using a single, static algorithm, the present techniques can allow for a list of algorithms that can be used in a priority order. This can mean that if a vulnerability is discovered in one algorithm, the SED can automatically switch to the next secure algorithm from the list to create new encryption key. This approach can provide a more robust and secure solution, relative to prior approaches, as it can ensure that the encryption key can always be updated to an encryption algorithm available at that point of time that is believed to be secure.

The present techniques can be implemented to seamlessly update the encryption key used by a SED from a vulnerable algorithm to a more secure algorithm without disrupting the user's access to their data. This can be accomplished by reading the data using the old encryption key, encrypting it again using the new key, and overwriting the old data with the new encrypted data. This can ensure that the data remains accessible and intact, while the old encryption key is replaced with a more secure one, all without interrupting the user's workflow. Once new encryption key is operational, the old encryption key (which can use a vulnerable algorithm) can be disabled. This approach can handle a situation where changing encryption key does not make SED data inaccessible.

In some examples, this can be added as a default feature for new SEDs and implemented through a firmware update for existing SEDs. A firmware update can ensure that the new encryption key is updated, and SED data is encrypted using this new key and stored in SED. The old encryption key and its possibly-vulnerable algorithm/cipher can then be removed or disabled to avoid future usage. This approach can ensure that changing encryption key to new secure algorithm does not make SED data inaccessible.

In some examples, removing or disabling a cipher can comprise removing it from a list of ciphers, and/or moving the cipher to a list of disabled ciphers.

It can be that, rather than being directed to detecting algorithm vulnerabilities, the present techniques are directed to instructing a SED to switch to a more secure algorithm and create a new encryption key (such as when a current encryption algorithm is found to be vulnerable).

Prior approaches to securing data on a SED can use a single encryption algorithm (AES) to encrypt and decrypt the data. This algorithm can be used to generate the encryption key and can be responsible for protecting the data stored on the SED. It can have a problem: it can be vulnerable to attacks if a vulnerability is discovered in the algorithm. If a vulnerability is discovered, an attacker could potentially exploit it to access the data stored on the SED, which could be disastrous for the data owner.

A problem with prior approaches is that it does not provide a mechanism to update the encryption algorithm or key in the event of a vulnerability. This means that if a vulnerability is discovered, it can be that the only way to protect the data is to stop using the SED, which could be a significant disruption to the data owner's operations. Moreover, the data stored on the SED could be at risk of being compromised, which could have serious consequences for the data owner. Therefore, there can be a need to develop a new approach that allows the encryption algorithm or key to be updated in the event of a vulnerability, ensuring that the data remains secure and accessible. This can be addressed through implementing the present techniques.

The present techniques can be implemented to offer multiple algorithm support. That is, the present techniques can provide for multiple encryption algorithms to be used to create the encryption key, providing flexibility and security.

The present techniques can be implemented to offer a priority order. That is, the present techniques can allow for a priority order to be set for the algorithms, which can facilitate using a most-secure algorithm of the algorithms.

The present techniques can be implemented to facilitate data preservation. That is, the present techniques can ensure that the data remains accessible and intact during the update process, without disrupting the user's workflow.

The present techniques can be implemented to provide a dynamic mechanism that supports a list of secure algorithms, sets them in priority order, and uses the most secure algorithm to create the encryption key. This mechanism also can disable or remove an algorithm from the list if it is found to be vulnerable.

In some examples of the present techniques, the following steps can be implemented. It can be appreciated that there can be examples of the present techniques that implement more (or fewer) steps, and/or that implement these steps in a different order.

Step 1: Identify a list of algorithms to be used for encryption in SED. This can be a list of algorithms that are considered secure and suitable for use in SEDs. The list can be prioritized in order of security, with the most secure algorithms first.

Step 2: Implement the algorithm selection mechanism. This can comprise implementing a mechanism to allow for the selection of an algorithm from the list. This can comprise traversing forward in a list from a current algorithm to a next algorithm.

Step 3: Set next secure algorithm to create new encryption key (through firmware instructions). Where a vulnerability is discovered in the current algorithm that the SED is using, then select the next algorithm from the list. To achieve this, Trusted Computing Group (TCG) protocols or Small Computer System Interface (SCSI) security PROTOCOL IN/OUT commands can be used, which can act an interface between a SED host system that manages the SED drive, and the actual SED drive. In this way, the SED can the set the next algorithm in the list to create the new encryption key and to disable the existing encryption key.

SCSI security PROTOCOL IN and PROTOCOL OUT commands can be used for communication between a storage device and a corresponding host system, and can facilitate encryption, authentication, and security-related operations. A PROTOCOL IN command can be used to fetch security information, such as encryption keys, certificates, and challenge responses. A PROTOCOL OUT command can be used to send security-related data to the storage device, such as authentication credentials, encryption keys, or security configuration commands.

Step 4: Make sure data is accessible with new encryption key. Use the new algorithm to generate a new encryption key for the SED. At this point in time, the SED can have both keys in use (the old encryption key and the new encryption key). Read the SED data using the old encryption key. Store the data in a data buffer in the SED. Use the new encryption key to encrypt the data stored in the buffer. Then, overwrite the old data stored on the SED with the new encrypted data from the data buffer.

Repeat this for the remainder of the SED's disk data. In some examples, overwrite the entire SED with the new encrypted data, rather than just updating a portion of the data.

To do this, a “data buffer within the SED” and/or another swap/temporary disk can be used to rewrite data to SED using the new encryption key. For example, read existing data from the SED using the old encryption key (TCG/SCSI protocols for data read) onto the host machine. The host machine can save/copy the SED data to swap/temporary disk. Once the data is copied, the SED can be instructed (using TCG/SCSI protocols) to use the next algorithm in the list for encryption and create new encryption key in the SED using new algorithm.

The host machine can then rewrites back this data to the SED (by this time, it can be that the SED has already set a new encryption key using new algorithm, so all this data can be written using the new encryption key). This way, data is preserved on the SED and it has also been moved from a vulnerable

algorithm encryption key to new secure algorithm encryption key.

Step 5: Remove the old encryption key and disable the vulnerable algorithm. Remove the old encryption key from the SED. Disable the vulnerable algorithm used by the SED. This can ensure that the SED will not use vulnerable algorithms in the future for creating a DEK and that user data is safeguarded from vulnerabilities.

Step 6: Encrypt and decrypt the data using the selected algorithm. Henceforth, the future encryption and decryption operations in the SED can be done using this new DEK.

The present techniques can be implemented to provide increased security, reduced maintenance costs, and increased customer trust.

With regard to increased security, the present techniques can provide an additional layer of security (relative to prior approaches) by allowing for the selection of the most secure encryption algorithm at any given time, reducing the risk of data breaches and unauthorized access.

With regard to reduced maintenance costs, an ability to dynamically update the encryption algorithm and key can reduce the need for manual updates and maintenance, resulting in reduced costs for users and increased efficiency.

With regard to increased user trust, by providing an additional layer of security and ensuring that data remains protected, the present techniques can increase user trust and confidence in the SED technology, leading to increased adoption and loyalty.

In some examples, a data buffer within the SED can be used while re-encrypting data with the new key. In some examples a separate temporary storage device can be used, which is external to the SED. With regard to serving read requests during the second example, while data is being written to the temporary storage device, data can be read from the SED, using the old encryption key.

While data is written back from the temporary storage device and to the SED (where it is encrypted on the SED with the new storage key), it can be that the temporary storage device serves read requests rather than the SED. This can occur while a copy operation occurs from data from the temporary storage device and to the SED (using the new key). So, even if the SED stores a mix of data encrypted with the old key and data encrypted with the new key, reads can be served by the temporary storage drive, which can render moot which key to use to decrypt data on the SED. Once copying back to the SED completes, the old algorithm/cipher and the old key can be disabled from the SED. The temporary storage device can then be disabled with respect to serving read requests.

In the case of a failure during transitioning between keys (e.g., a power outage), then the copy operation can start from the beginning of the disk again to ensure that key conversion on the SED happens completely (instead of deciding a resume point).

A SED can comprise two logical areas-a system band and a data band. The system band can comprise a small, reserved portion that is used for authentication and security management. It can store encryption keys. The data band can comprise a portion in which files are stored. It can be that, during a key switch, the system band stores both the existing key and the new key, where the new key will replace the existing key after the key switch. During the key switch, data can be read and decrypted with the existing key, then encrypted with the new key and written. Once all data on the SED is overwritten as encrypted with the new key, a successful key switch can be confirmed, and the existing key can be discarded.

### Example Architectures, Etc.

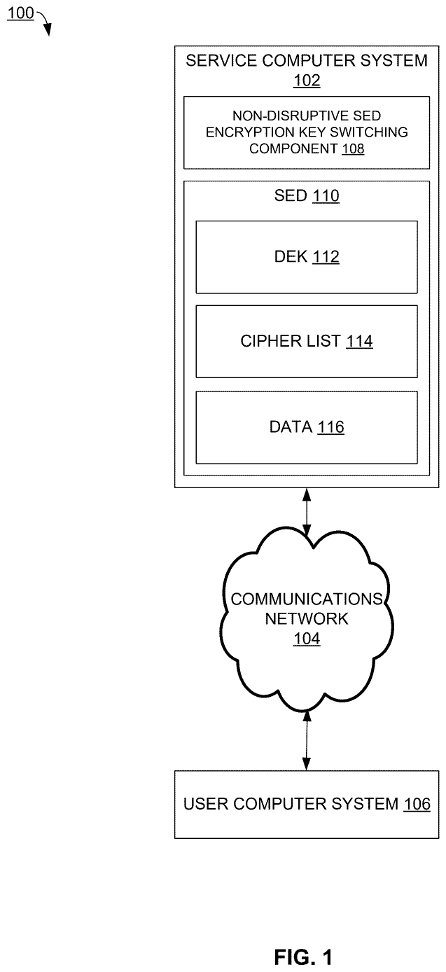

FIG. 1 illustrates an example system architecture 100 that can facilitate non-disruptive SED encryption key switching, in accordance with an embodiment of this disclosure.

System architecture 100 comprises computer system 102, communications network 104, and user computer system 106. Computer system 102 comprises non-disruptive SED encryption key switching component 108, and SED 110. In turn, SED 110 comprises DEK 112, cipher list 114, and data 116.

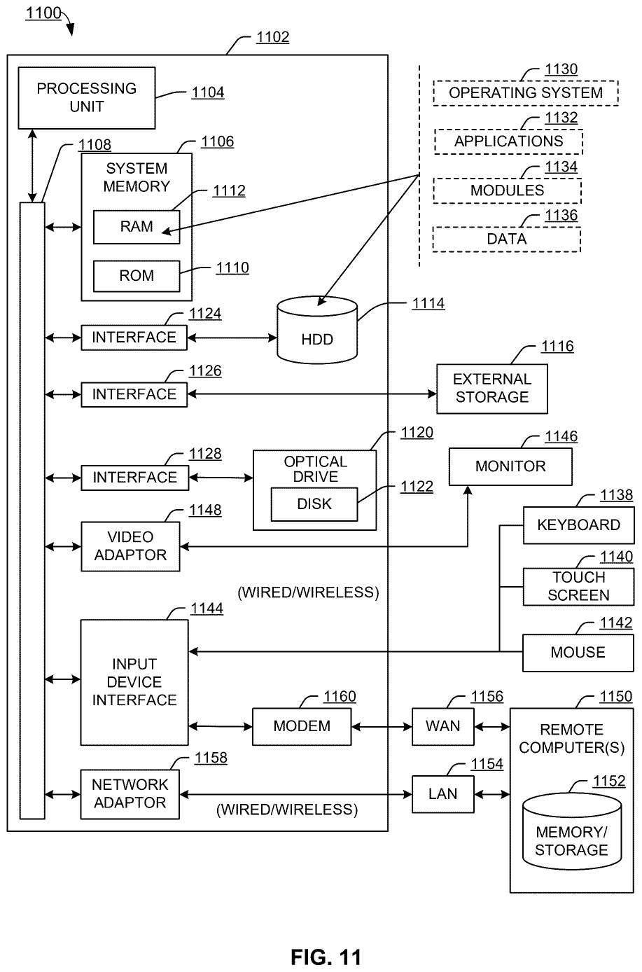

Each of computer system 102 and/or user computer system 106 can be implemented with part(s) of computing environment 1100 of FIG. 11. Communications network 104 can comprise a computer communications network, such as the Internet.

User computer system 106 can communicate with computer system 102 via communications network 104 to read and/or write data on SED 110. While this occurs, a non-disruptive SED encryption key switch on SED 110 can also occur.

Non-disruptive SED encryption key switching component 108 can effectuate switching an encryption key used by SED 110 to encrypt data 116, without disrupting access to data 116.

Non-disruptive SED encryption key switching component 108 can manage this switch, such as by determining to use another cipher from cipher list 114, and producing a new key from the next cipher in cipher list 114, where DEK 112 is the key in use by SED 110.

With this new key (and where the key that was used to encrypt data 116 is referred to as the old key), data from 116 can be read and decrypted. It can be stored on SED 110 in a data buffer or on another storage device, for example. Once all the data has been read, DEK 112 can be updated with the new key, so that when the data is written back to SED 110, it will be encrypted by DEK 112 (using the new key) and stored in data 116.

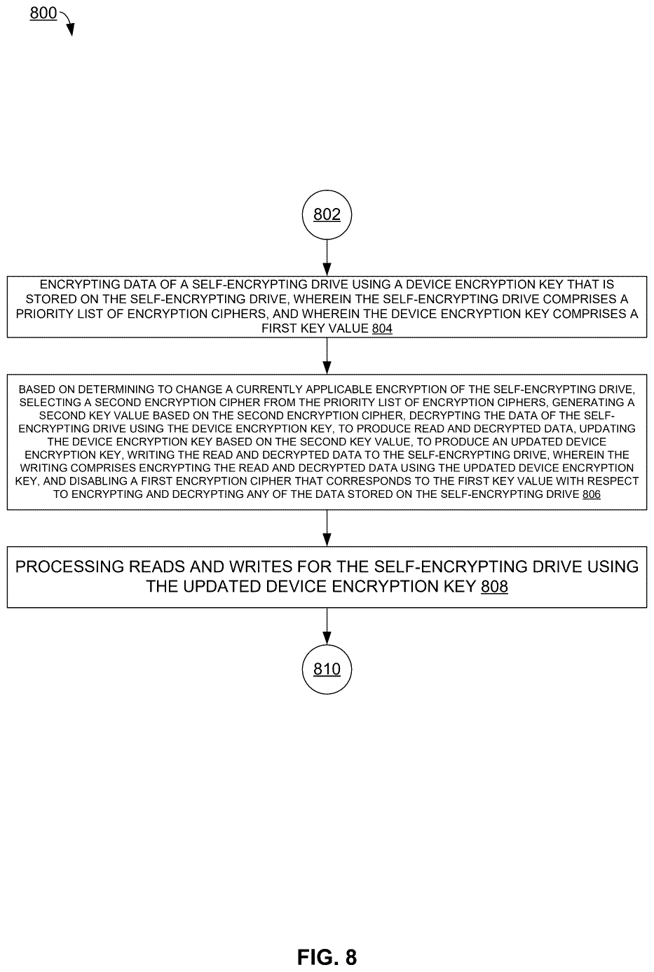

In some examples, non-disruptive SED encryption key switching component 108 can implement part(s) of the process flows of FIGS. 8-10 to implement non-disruptive SED encryption key switching.

It can be appreciated that system architecture 100 is one example system architecture for non-disruptive SED encryption key switching, and that there can be other system architectures that facilitate non-disruptive SED encryption key switching.

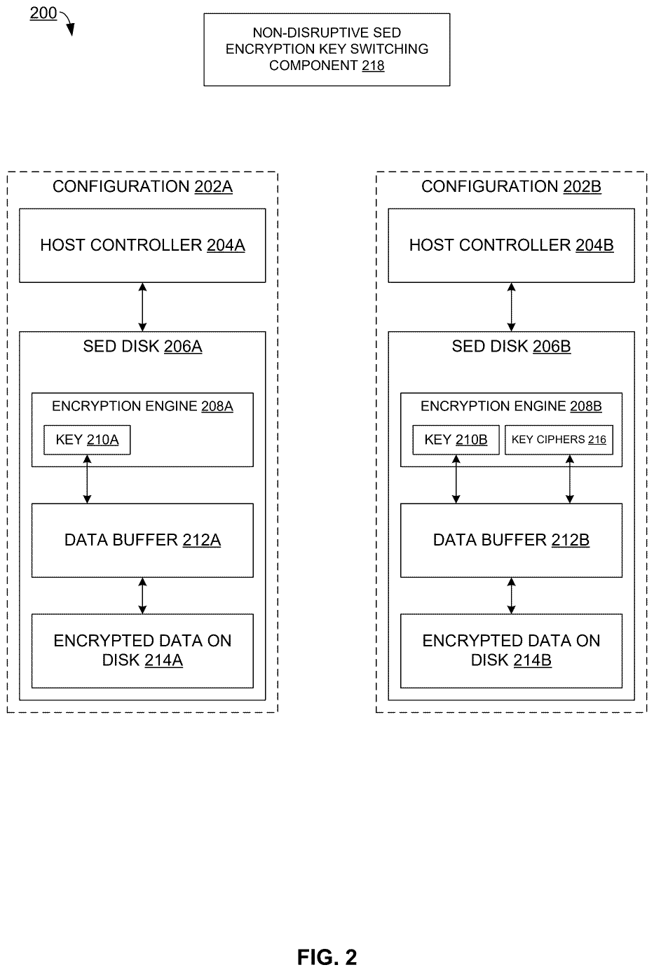

FIG. 2 illustrates an example 200 of non-disruptive SED encryption key switching, in accordance with an embodiment of this disclosure. In some examples, part(s) of example 200 can be implemented by part(s) of system architecture 100 of FIG. 1.

Example 200 comprises non-disruptive SED encryption key switching component 218 (which can be similar to non-disruptive SED encryption key switching component 108 of FIG. 1), and different SED configurations-configuration 202A and configuration 202B.

One configuration, configuration 202A, comprises host controller 204A, SED disk 206A, encryption engine 208A, key 210A, data buffer 212A, and encrypted data on disk 214A.

Another configuration, configuration 202B, comprises host controller 204B, SED disk 206B, encryption engine 208B, key 210B, data buffer 212B, encrypted data on disk 214B, and key ciphers 216.

In configuration 202A, if key 210A is compromised, a new key cannot be used in its place. In contrast, according to the present techniques, in configuration 202B, if key 210B is compromised, a new key can be used in its place, by generating one using a cipher from key ciphers 216.

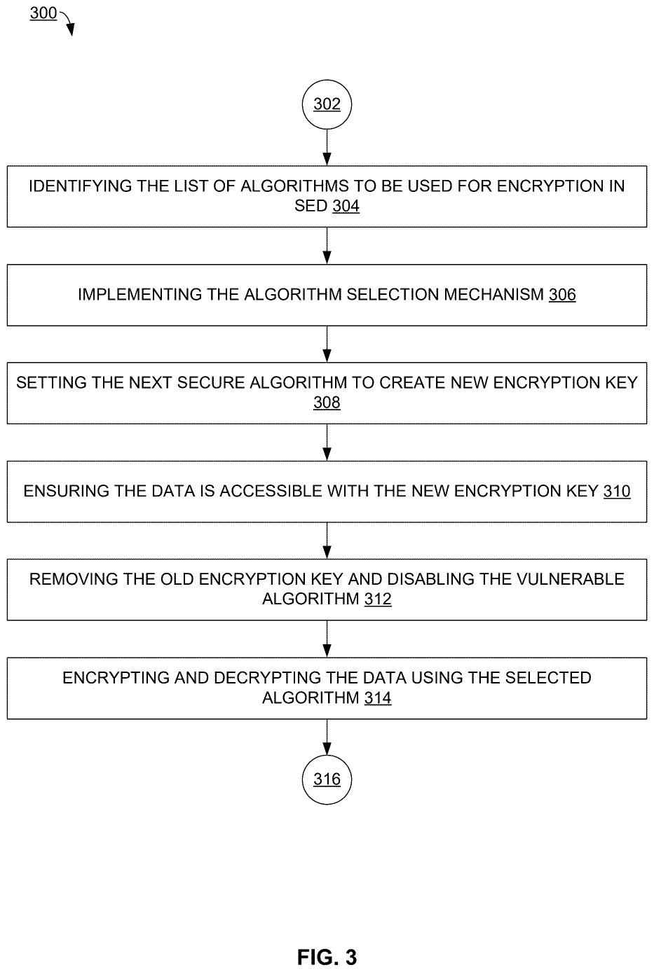

FIG. 3 illustrates an example process flow 300 that can facilitate non-disruptive SED encryption key switching, in accordance with an embodiment of this disclosure. In some examples, one or more embodiments of process flow 300 can be implemented by non-disruptive SED encryption key switching component 108 of FIG. 1, or computing environment 1100 of FIG. 11.

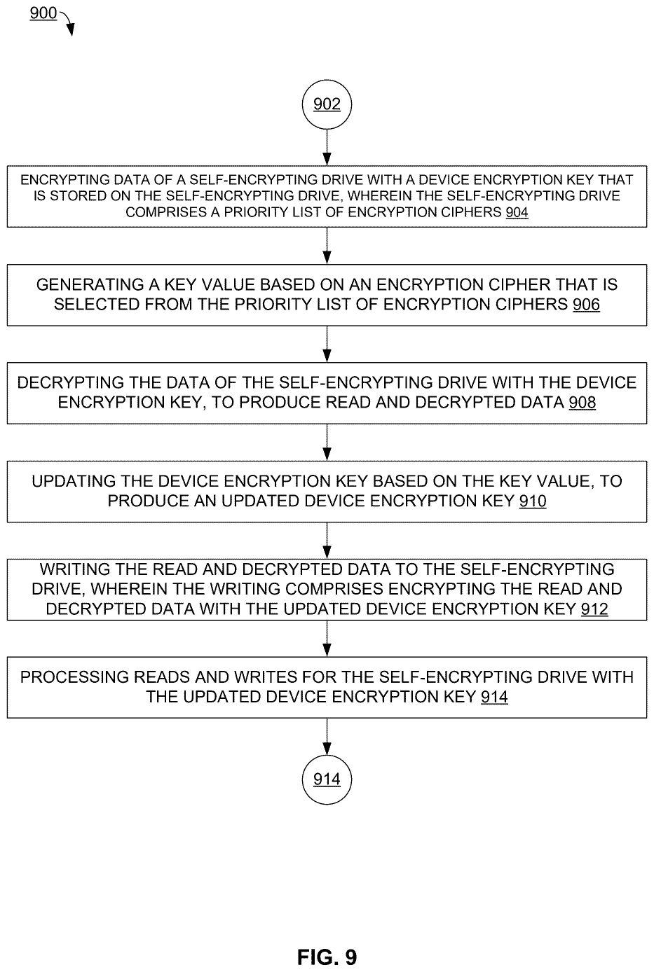

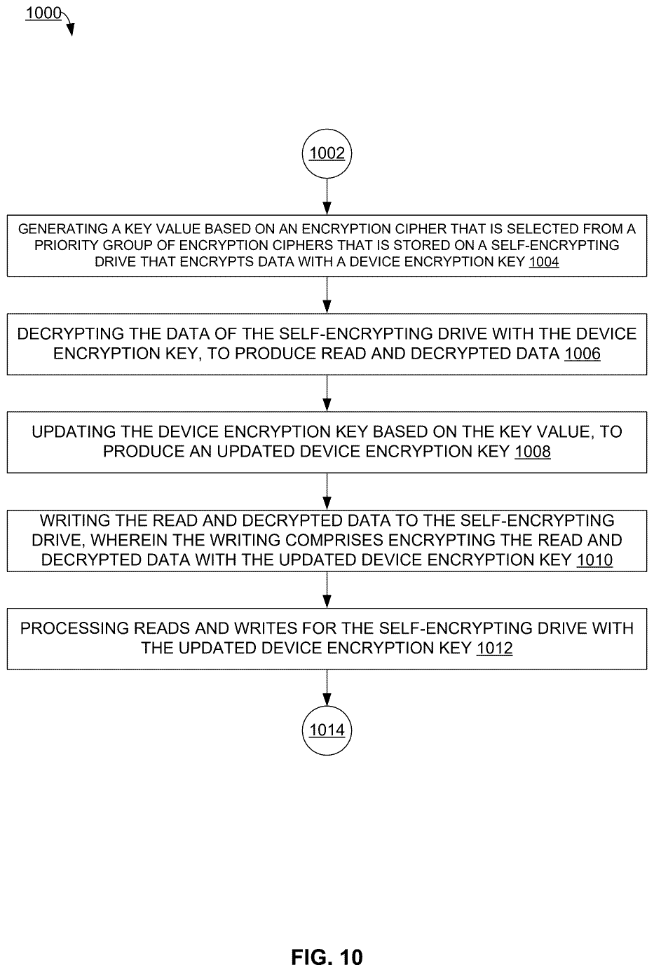

It can be appreciated that the operating procedures of process flow 300 are example operating procedures, and that there can be embodiments that implement more or fewer operating procedures than are depicted, or that implement the depicted operating procedures in a different order than as depicted. In some examples, process flow 300 can be implemented in conjunction with one or more embodiments of one or more of process flow 800 of FIG. 8, process flow 900 of FIG. 9, and/or process flow 1000 of FIG. 10.

Process flow 300 begins with 302, and moves to operation 304.

Operation 304 depicts identifying the list of algorithms to be used for encryption in SED. This can be implemented in a similar manner as step 1 described above.

After operation 304, process flow 300 moves to operation 306.

Operation 306 depicts implementing the algorithm selection mechanism. This can be implemented in a similar manner as step 2 described above.

After operation 306, process flow 300 moves to operation 308.

Operation 308 depicts setting the next secure algorithm to create new encryption key. This can be implemented in a similar manner as step 3 described above.

After operation 308, process flow 300 moves to operation 310.

Operation 310 depicts ensuring the data is accessible with the new encryption key. This can be implemented in a similar manner as step 4 described above.

After operation 310, process flow 300 moves to operation 312.

Operation 312 depicts removing the old encryption key and disabling the vulnerable algorithm. This can be implemented in a similar manner as step 5 described above.

After operation 312, process flow 300 moves to operation 314.

Operation 314 depicts encrypting and decrypting the data using the selected algorithm. This can be implemented in a similar manner as step 6 described above.

After operation 314, process flow 300 moves to 316, where process flow 300 ends.

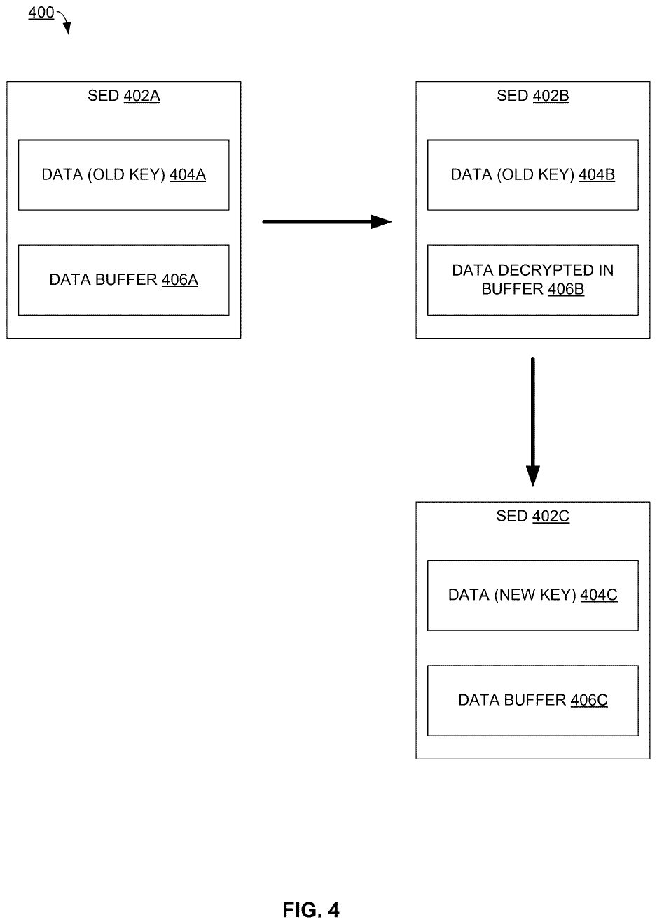

FIG. 4 illustrates an example 400 of an on-SED data buffer, and that can facilitate non-disruptive SED encryption key switching, in accordance with an embodiment of this disclosure. In some examples, part(s) of example 400 can be implemented by part(s) of system architecture 100 of FIG. 1.

Example 400 comprises a SED at three points in time, as non-disruptive SED encryption key switching. A first point in time is illustrated with SED 402A, data (old key) 404A, and data buffer 406A. A second point in time is illustrated with SED 402B, data (old key) 404B, and data decrypted in buffer 406B. A third point in time is illustrated with SED 402C, data (new key) 404C, and data buffer 406C.

A non-disruptive key switch can occur as follows. Data (old key) 404B can be decrypted with the old key and stored in data decrypted in buffer 406B. Then the data from data decrypted in buffer 406B can be written back and encrypted with a new key, as shown with data (new key) 404C.

In this manner, data can be read decrypted with the old key, and re-encrypted and stored with the new key, using an on-SED buffer.

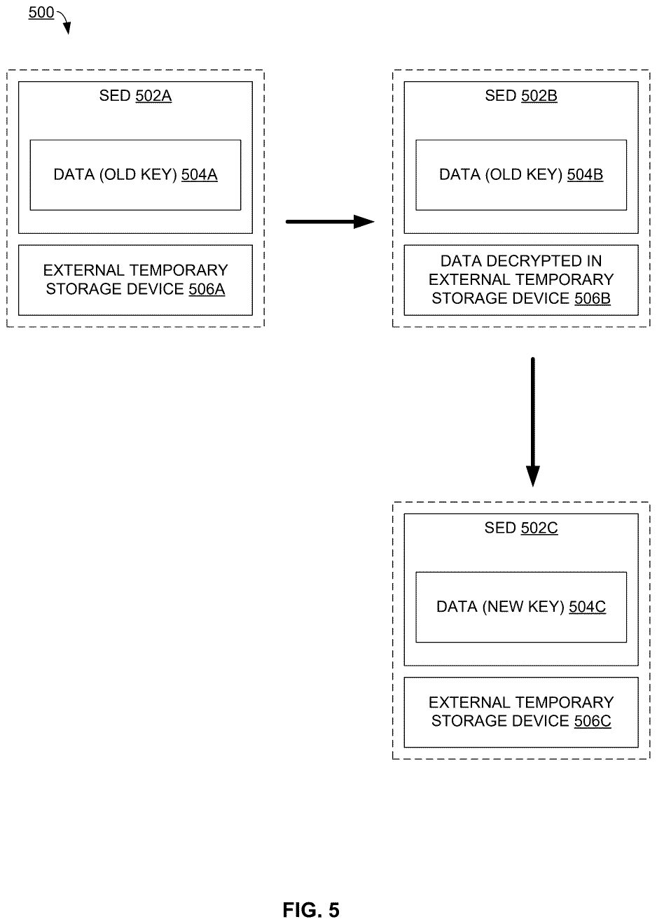

FIG. 5 illustrates an example 500 of separate temporary storage device, and that can facilitate non-disruptive SED encryption key switching, in accordance with an embodiment of this disclosure. In some examples, part(s) of example 500 can be implemented by part(s) of system architecture 100 of FIG. 1.

Example 500 comprises a SED at three points in time, as non-disruptive SED encryption key switching. A first point in time is illustrated with SED 502A, data (old key) 504A, and external temporary storage device 506A. A second point in time is illustrated with SED 502B, data (old key) 504B, and data decrypted in external temporary storage device 506B. A third point in time is illustrated with SED 502C, data (new key) 504C, and external temporary storage device 506C.

This can be similar to example 400 of FIG. 4, where an external storage device (e.g., external temporary storage device 506A) is used in example 500 compared to an on-SED buffer in example 400.

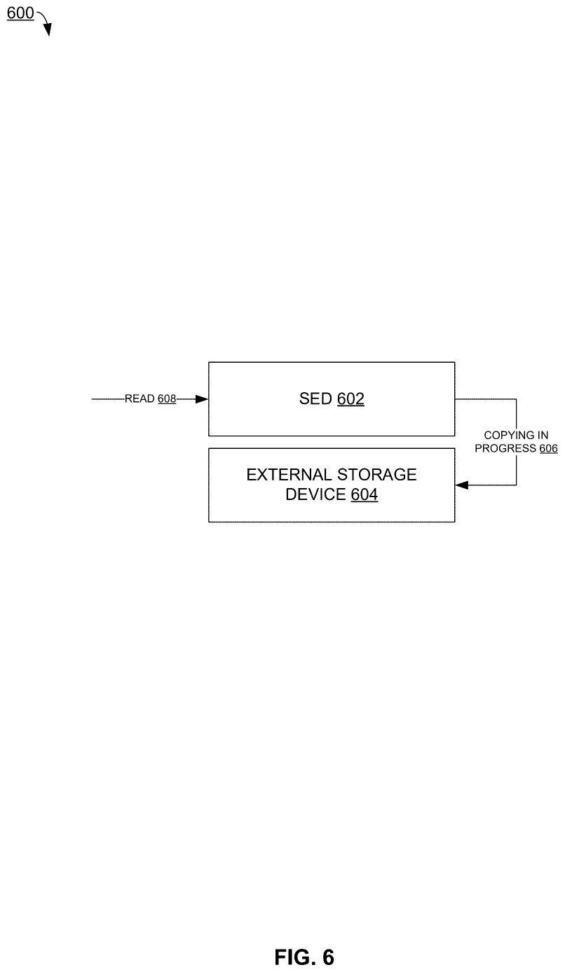

FIG. 6 illustrates an example 600 of performing a read while performing facilitate non-disruptive SED encryption key switching, and that can facilitate non-disruptive SED encryption key switching, in accordance with an embodiment of this disclosure. In some examples, part(s) of example 600 can be implemented by part(s) of system architecture 100 of FIG. 1.

Example 600 comprises SED 602, external storage device 604, copying in progress 606, and read 608. In example 600, data is being decrypted and copied from SED 602 to external storage device 604. While this occurs, reads directed to SED 602 can be served by SED 602, since SED 602 still has a full copy of its data.

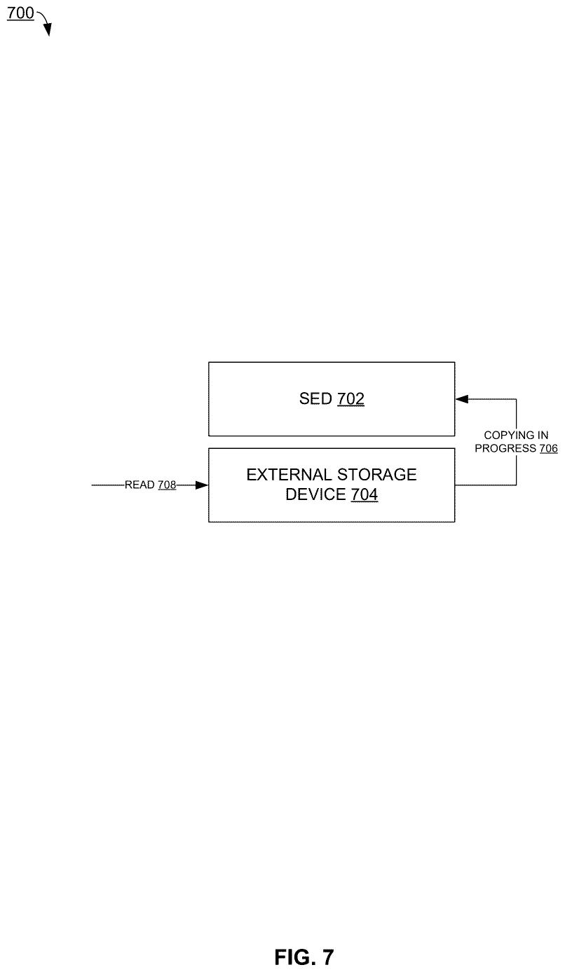

FIG. 7 illustrates another example 700 of performing a read while performing facilitate non-disruptive SED encryption key switching, and that can facilitate non-disruptive SED encryption key switching, in accordance with an embodiment of this disclosure. In some examples, part(s) of example 700 can be implemented by part(s) of system architecture 100 of FIG. 1.

Example 700 comprises SED 702, external storage device 704, copying in progress 706, and read 708. In example 700, data is copied from external storage device 704 back to SED 702 (where it is encrypted with a new key before being stored). While this occurs, reads directed to SED 702 can be served by external storage device 704, since external storage device 704 has a full copy of the data (and SED 702 can have only a partial copy, with some data that was encrypted with the old key being overwritten with other data encrypted with the new key).

### Example Process Flows

FIG. 8 illustrates an example process flow 800 that can facilitate non-disruptive SED encryption key switching, in accordance with an embodiment of this disclosure. In some examples, one or more embodiments of process flow 800 can be implemented by non-disruptive SED encryption key switching component 108 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 300 of FIG. 3, process flow 900 of FIG. 9, and/or process flow 1000 of FIG. 10.

Process flow 800 begins with 802, and moves to operation 804.

Operation 804 depicts encrypting data of a self-encrypting drive using a device encryption key that is stored on the self-encrypting drive, wherein the self-encrypting drive comprises a priority list of encryption ciphers, and wherein the device encryption key comprises a first key value. Using the example of FIG. 1, the self-encrypting drive can be SED 110, the device encryption key can be DEK 112, and the priority list of encryption ciphers can be cipher list 114.

In some examples, the priority list of encryption ciphers comprises respective ciphers that are ordered based on a security criterion. That is, the present techniques can allow for a list of algorithms that can be used in a priority order. This can mean that if a vulnerability is discovered in one algorithm, the SED can automatically switch to the next secure algorithm from the list to create new encryption key.

In some examples, use of the priority list of encryption ciphers is enabled via a firmware update to the self-encrypting drive. In some examples, this firmware update can comprise a trusted computing group protocol command or a small computer system interface protocol IN/OUT command.

In some examples, operation 804 comprises writing the priority list of encryption ciphers to the self-encrypting drive via a trusted computing group protocol command. In some examples, operation 804 comprises writing the priority list of encryption ciphers to the self-encrypting drive via a small computer system interface protocol IN/OUT command. That is, Trusted Computing Group (TCG) protocols or Small Computer System Interface (SCSI) security PROTOCOL IN/OUT commands can be used, which can act an interface between a SED host system that manages the SED drive, and the actual SED drive.

After operation 804, process flow 800 moves to operation 806.

Operation 806 depicts, based on determining to change a currently applicable encryption of the self-encrypting drive, selecting a second encryption cipher from the priority list of encryption ciphers, generating a second key value based on the second encryption cipher, decrypting the data of the self-encrypting drive using the device encryption key, to produce read and decrypted data, updating the device encryption key based on the second key value, to produce an updated device encryption key, writing the read and decrypted data to the self-encrypting drive, wherein the writing comprises encrypting the read and decrypted data using the updated device encryption key, and disabling a first encryption cipher that corresponds to the first key value with respect to encrypting and decrypting any of the data stored on the self-encrypting drive. This can be implemented in a similar manner as process flow 300 of FIG. 3.

In some examples, the encryption cipher is a second encryption cipher, wherein the first key value is generated based on a first encryption cipher, and wherein the determining to change the currently applicable encryption of the self-encrypting drive occurs based on identifying a vulnerability with the first encryption cipher. That is, if a vulnerability is discovered in one algorithm, the SED can automatically switch to the next secure algorithm from the list to create new encryption key. This approach can provide a more robust and secure solution, relative to prior approaches, as it can ensure that the encryption key can always be updated to an encryption algorithm available at that point of time that is believed to be secure.

After operation 806, process flow 800 moves to operation 808.

Operation 808 depicts processing reads and writes for the self-encrypting drive using the updated device encryption key. That is, after the data has been encrypted and stored with the new DEK, the SED can use the new DEK for reads and writes.

After operation 808, process flow 800 moves to 810, where process flow 800 ends.

FIG. 9 illustrates an example process flow 900 that can facilitate non-disruptive SED encryption key switching, in accordance with an embodiment of this disclosure. In some examples, one or more embodiments of process flow 900 can be implemented by non-disruptive SED encryption key switching component 108 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 300 of FIG. 3, process flow 800 of FIG. 8, and/or process flow 1000 of FIG. 10.

Process flow 900 begins with 902, and moves to operation 904.

Operation 904 depicts encrypting data of a self-encrypting drive with a device encryption key that is stored on the self-encrypting drive, wherein the self-encrypting drive comprises a priority list of encryption ciphers. In some examples, operation 904 can be implemented in a similar manner as operation 804 of FIG. 8.

After operation 904, process flow 900 moves to operation 906.

Operation 906 depicts generating a key value based on an encryption cipher that is selected from the priority list of encryption ciphers. In some examples, operation 906 can be implemented in a similar manner as operation 806 of FIG. 8.

After operation 906, process flow 900 moves to operation 908.

Operation 908 depicts decrypting the data of the self-encrypting drive with the device encryption key, to produce read and decrypted data. In some examples, operation 908 can be implemented in a similar manner as operation 806 of FIG. 8.

In some examples, the read and decrypted data is stored in a data buffer of the self-encrypting drive, wherein the writing of the read and decrypted data to the self-encrypting drive is performed to a main storage area of the self-encrypting drive, and wherein the main storage area des not comprise the data buffer. In some examples, the read and decrypted data is stored in a storage device that is external to the self-encrypting drive. That is, a data buffer within the SED and/or a temporary external storage drive can be used while switching keys on the SED.

In some examples, the read and decrypted data is stored in a buffer, and operation 908 comprises, while performing the decrypting the data of the self-encrypting drive with the device encryption key, processing a read request to the self-encrypting drive with the data of the self-encrypting drive. This can be implemented in a similar manner as depicted with respect to FIG. 6.

In some examples, the read and decrypted data is stored in a buffer, and operation 908 comprises, while performing the writing of the read and decrypted data to the self-encrypting drive, processing a read request to the self-encrypting drive with the buffer. This can be implemented in a similar manner as depicted with respect to FIG. 7.

In some examples, while performing the writing of the read and decrypted data to the self-encrypting drive, the self-encrypting drive stores a combination of first data that is encrypted with the updated device encryption key and second data that is encrypted with the device encryption key. In some examples, the read request is a first read request, and operation 908 comprises, after completing the performing of the writing of the read and decrypted data to the self-encrypting drive, processing a second read request to the self-encrypting drive with the self-encrypting drive. That is, while writing data encrypted with the new key to the SED, it can be that reads are not served from the SED's main data storage (but can be served with a SED data buffer) because at this point in time the SED stores a mix of data encrypted with the old key and data encrypted with the new key. After writing the data encrypted with the new key is completed, read requests can be served with the SED's main data storage.

After operation 908, process flow 900 moves to operation 910.

Operation 910 depicts updating the device encryption key based on the key value, to produce an updated device encryption key. In some examples, operation 910 can be implemented in a similar manner as operation 806 of FIG. 8.

After operation 910, process flow 900 moves to operation 912.

Operation 912 depicts writing the read and decrypted data to the self-encrypting drive, wherein the writing comprises encrypting the read and decrypted data with the updated device encryption key. In some examples, operation 912 can be implemented in a similar manner as operation 806 of FIG. 8.

Inn some examples, the writing of the read and decrypted data to the self-encrypting drive comprises overwriting all of the data on the self-encrypting drive. That is, after implementing process flow 900 it can be that there is no data on the self-encrypting drive that is encrypted with the old key. In examples where the SED implements block storage, then the blocks that store data encrypted with the old key can be identified and overwritten with blocks that store corresponding data with the new key.

After operation 912, process flow 900 moves to operation 914.

Operation 914 depicts processing reads and writes for the self-encrypting drive with the updated device encryption key. In some examples, operation 914 can be implemented in a similar manner as operation 808 of FIG. 8.

After operation 914, process flow 900 moves to 916, where process flow 900 ends.

FIG. 10 illustrates an example process flow 1000 that can facilitate non-disruptive SED encryption key switching, in accordance with an embodiment of this disclosure. In some examples, one or more embodiments of process flow 1000 can be implemented by non-disruptive SED encryption key switching component 108 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 300 of FIG. 3, process flow 800 of FIG. 8, and/or process flow 900 of FIG. 9.

Process flow 1000 begins with 1002, and moves to operation 1004.

Operation 1004 depicts generating a key value based on an encryption cipher that is selected from a priority group of encryption ciphers that is stored on a self-encrypting drive that encrypts data with a device encryption key. In some examples, operation 1004 can be implemented in a similar manner as operation 806 of FIG. 8.

In some examples, respective ciphers of the priority group of encryption ciphers are ordered based on a security criterion.

In some examples, the encryption cipher is a first encryption cipher that differs from a second encryption cipher used to generate the device encryption key.

In some examples, use of the priority group of encryption ciphers is enabled via a firmware update to the self-encrypting drive.

After operation 1004, process flow 1000 moves to operation 1006.

Operation 1006 depicts decrypting the data of the self-encrypting drive with the device encryption key, to produce read and decrypted data. In some examples, operation 1006 can be implemented in a similar manner as operation 806 of FIG. 8.

After operation 1006, process flow 1000 moves to operation 1008.

Operation 1008 depicts updating the device encryption key based on the key value, to produce an updated device encryption key. In some examples, operation 1008 can be implemented in a similar manner as operation 806 of FIG. 8.

After operation 1008, process flow 1000 moves to operation 1010.

Operation 1010 depicts writing the read and decrypted data to the self-encrypting drive, wherein the writing comprises encrypting the read and decrypted data with the updated device encryption key. In some examples, operation 1010 can be implemented in a similar manner as operation 806 of FIG. 8.

In some examples, the read and decrypted data is stored in a data buffer of the self-encrypting drive, the writing of the read and decrypted data to the self-encrypting drive is performed to a main storage area of the self-encrypting drive, and operation 1010 comprises deleting the read and decrypted data from the data buffer after performing the writing of the read and decrypted data to the self-encrypting drive.

In some examples, the read and decrypted data is stored in a storage device that is external to the self-encrypting drive, and operation 1010 comprises deleting the read and decrypted data from the storage device after performing the writing of the read and decrypted data to the self-encrypting drive. That is, where a data buffer or external temporary drive is used, the data from the SED that is stored in the data buffer/external temporary drive can be deleted after completing the key switch on the SED.

After operation 1010, process flow 1000 moves to operation 1012.

Operation 1012 depicts processing reads and writes for the self-encrypting drive with the updated device encryption key. In some examples, operation 1012 can be implemented in a similar manner as operation 808 of FIG. 8.

After operation 1012, process flow 1000 moves to 1014, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of computer system 102, and/or user computer system 106.

In some examples, computing environment 1100 can implement one or more embodiments of the process flows of FIGS. 8-10 to facilitate non-disruptive SED encryption key switching.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can also be connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
encrypting data of a self-encrypting drive using a device encryption key that is stored on the self-encrypting drive, wherein the self-encrypting drive comprises a priority list of encryption ciphers, and wherein the device encryption key comprises a first key value;
based on determining to change a currently applicable encryption of the self-encrypting drive,
selecting a second encryption cipher from the priority list of encryption ciphers,
generating a second key value based on the second encryption cipher,
decrypting the data of the self-encrypting drive using the device encryption key, to produce read and decrypted data,
updating the device encryption key based on the second key value, to produce an updated device encryption key,
writing the read and decrypted data to the self-encrypting drive, wherein the writing comprises encrypting the read and decrypted data using the updated device encryption key, and
disabling a first encryption cipher that corresponds to the first key value with respect to encrypting and decrypting any of the data stored on the self-encrypting drive; and
processing reads and writes for the self-encrypting drive using the updated device encryption key.

2. The system of claim 1, wherein the priority list of encryption ciphers comprises respective ciphers that are ordered based on a security criterion.

3. The system of claim 1, wherein the encryption cipher is a second encryption cipher, wherein the first key value is generated based on a first encryption cipher, and wherein the determining to change the currently applicable encryption of the self-encrypting drive occurs based on identifying a vulnerability with the first encryption cipher.

4. The system of claim 1, wherein use of the priority list of encryption ciphers is enabled via a firmware update to the self-encrypting drive.

5. The system of claim 1, wherein the operations further comprise:
writing the priority list of encryption ciphers to the self-encrypting drive via a trusted computing group protocol command.

6. The system of claim 1, wherein the operations further comprise:
writing the priority list of encryption ciphers to the self-encrypting drive via a small computer system interface protocol IN/OUT command.

7. A method, comprising:
encrypting, by a system comprising at least one processor, data of a self-encrypting drive with a device encryption key that is stored on the self-encrypting drive, wherein the self-encrypting drive comprises a priority list of encryption ciphers;
generating, by the system, a key value based on an encryption cipher that is selected from the priority list of encryption ciphers;
decrypting, by the system, the data of the self-encrypting drive with the device encryption key, to produce read and decrypted data;
updating, by the system, the device encryption key based on the key value, to produce an updated device encryption key;
writing, by the system, the read and decrypted data to the self-encrypting drive, wherein the writing comprises encrypting the read and decrypted data with the updated device encryption key; and
processing, by the system, reads and writes for the self-encrypting drive with the updated device encryption key.

8. The method of claim 7, wherein the read and decrypted data is stored in a data buffer of the self-encrypting drive, wherein the writing of the read and decrypted data to the self-encrypting drive is performed to a main storage area of the self-encrypting drive, and wherein the main storage area des not comprise the data buffer.

9. The method of claim 7, wherein the read and decrypted data is stored in a storage device that is external to the self-encrypting drive.

10. The method of claim 7, wherein the writing of the read and decrypted data to the self-encrypting drive comprises overwriting all of the data on the self-encrypting drive.

11. The method of claim 7, wherein the read and decrypted data is stored in a buffer, and further comprising:
while performing the decrypting of the data of the self-encrypting drive with the device encryption key, processing, by the system, a read request to the self-encrypting drive with the data of the self-encrypting drive.

12. The method of claim 7, wherein the read and decrypted data is stored in a buffer, and further comprising:
while performing the writing of the read and decrypted data to the self-encrypting drive, processing, by the system, a read request to the self-encrypting drive with the buffer.

13. The method of claim 12, wherein, while performing the writing of the read and decrypted data to the self-encrypting drive, the self-encrypting drive stores a combination of first data that is encrypted with the updated device encryption key and second data that is encrypted with the device encryption key.

14. The method of claim 12, wherein the read request is a first read request, and further comprising:
after completing the performing of the writing of the read and decrypted data to the self-encrypting drive, processing, by the system, a second read request to the self-encrypting drive with the self-encrypting drive.

15. A non-transitory computer-readable medium comprising instructions that, in response to execution, cause a system comprising at least one processor to perform operations, comprising:
generating a key value based on an encryption cipher that is selected from a priority group of encryption ciphers that is stored on a self-encrypting drive that encrypts data with a device encryption key;
decrypting the data of the self-encrypting drive with the device encryption key, to produce read and decrypted data;
updating the device encryption key based on the key value, to produce an updated device encryption key;
writing the read and decrypted data to the self-encrypting drive, wherein the writing comprises encrypting the read and decrypted data with the updated device encryption key; and
processing reads and writes for the self-encrypting drive with the updated device encryption key.

16. The non-transitory computer-readable medium of claim 15, wherein the read and decrypted data is stored in a data buffer of the self-encrypting drive, wherein the writing of the read and decrypted data to the self-encrypting drive is performed to a main storage area of the self-encrypting drive, and wherein the operations further comprise:
deleting the read and decrypted data from the data buffer after performing the writing of the read and decrypted data to the self-encrypting drive.

17. The non-transitory computer-readable medium of claim 15, wherein the read and decrypted data is stored in a storage device that is external to the self-encrypting drive, and wherein the operations further comprise:
deleting the read and decrypted data from the storage device after performing the writing of the read and decrypted data to the self-encrypting drive.

18. The non-transitory computer-readable medium of claim 15, wherein respective ciphers of the priority group of encryption ciphers are ordered based on a security criterion.

19. The non-transitory computer-readable medium of claim 15, wherein the encryption cipher is a first encryption cipher that differs from a second encryption cipher used to generate the device encryption key.

20. The non-transitory computer-readable medium of claim 15, wherein use of the priority group of encryption ciphers is enabled via a firmware update to the self-encrypting drive.
